(19) United States
(12) Patent Application Publication
(10) Pub. No.: US 2003/0227248 A1
(43) Pub. Date: Dec. 11, 2003

(54) Electron gun for a cathode ray tube and a display device

(76) Inventor: Akihiro Kojima, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/443,785

(22) Filed: May 23, 2003

(30) Foreign Application Priority Data
Jun. 6, 2002 (JP) P2002-166242

(51) Int. Cl. H01J 29/46; H01J 29/50

(52) U.S. Cl. 313/442; 313/421; 313/441

(57) ABSTRACT

According to an electron gun for a cathode ray tube of the present invention, in an electron gun for a cathode ray tube which performs correction of an electron beam by applying a correction magnetic field to an electrode of the electron gun, at least a part of an electrode in a region which is affected by the correction magnetic field comprises a bellows-like electrode. According to the arrangement, a high frequency correction magnetic field from outside the cathode ray tube penetrates into the electrode more so that a preferable electron beam correction effect can be attained without disturbing the magnetic field.

### CROSS REFERENCES TO RELATED APPLICATIONS

The present document is based on Japanese Priority Document JP 2002-166242, filed in the Japanese Patent Office on Jun. 6, 2002, the entire contents of which being incorporated herein by reference.

### BACKGROUND OF THE INVENTION

1. Field of the Invention

The present invention relates to an electron gun for a cathode ray tube and also relates to a display device having the electron gun, such as a projector in which a monochrome color cathode ray tube is incorporated and a television receiver and a monitor in which a color cathode ray tube is incorporated and the like.

2. Description of the Related Art

Velocity modulation on electron beam deflection has been known as a method for making an outline of an image to be displayed on a cathode ray tube clear.

Here, the velocity modulation of electron beam deflection will be described. An electron beam is emitted from an electron gun and is horizontally scanned and vertically scanned by a deflection yoke so as to display an image on a cathode ray tube. Quantity of an electron beam (that is, a cathode current) is modulated in accordance with a size of an image signal. In order to make a brightness of a fluorescent screen, more electron beam is required to be emitted. This is because the more the electron beam (electric current quantity) radiating a fluorescent substance layer of the fluorescence screen is, the more a light emission intensity from the fluorescence screen increases.

In view of this, it is possible to delay the velocity of the electron beam and to extend a time period that the electron beam stays on a certain point on the fluorescence screen with regard to an image whose image intensity signal largely varies if a function of suppressing a scanning velocity of the electron beam as the image intensity signal severely changes is applied to a cathode ray tube, in addition to a deflection by a normal deflection yoke. Due to the arrangement, the more energy is injected to the fluorescent substance layer at that position through the electron beam so that the image there emits brighter and an outline thereof is more emphasized.

An electric field velocity modulation making use of an electric field and an electromagnetic velocity modulation making use of an electromagnetic coil have been known as a method realizing such an image whose outline is emphasized. According to the electric field velocity modulation, a bipolar structure of an electric field is formed at a part of an electron gun and an electric potential difference between two electrodes is changed in accordance with a change of the intensity signal of the image signal so that a scanning velocity is modulated in a scanning direction of the electron beam. On the other hand, according to the electromagnetic velocity modulation, an electromagnetic velocity modulation coil, such as a bipolar electromagnetic coil, is attached to a neck of a cathode ray tube having an electron gun therein and an electric current flowing through the coil is changed in accordance with the change of an intensity signal of an image signal so as to apply modulation of the scanning velocity.

By the way, practically, since 1) the electromagnetic velocity modulation can be realized without adding a special structure to the electron gun but simply attaching the bipolar electromagnetic coil at the neck of the cathode ray tube, and 2) the electric field velocity modulation adds a signal of a MHz band to the electrode as a signal for modulation, but it is difficult to transmit a high frequency signal to a specific electrode in the cathode ray tube whose inside is vacuum, the electromagnetic velocity modulation is widely employed.

### SUMMARY OF THE INVENTION

However, the electromagnetic velocity modulation also has a disadvantage. Generally, on a metal surface vertical to a magnetic line, a residual eddy current (magnetic field induced current) flows in a circumferential direction of the magnetic line. Here, when an external magnetic field changes at a time period, a magnetic field generated by the residual eddy current functions so as to eliminate the change of the external magnetic field. The position of the electron gun where the electromagnetic velocity modulation coil is attached is formed to be a cylindrical metal electrode. However, as the modulation frequency becomes higher in accordance with the above-mentioned phenomenon, less velocity modulation magnetic field penetrates into the position and a velocity modulation sensitivity becomes deteriorated.

Cutting the flow of the magnetic field induced current may be a method for improving the velocity modulation sensitivity. Specifically, in the electron gun in the vicinity of the electromagnetic velocity modulation coil, (1) an electrode may be divided; (2) a slit may be formed in the electrode (as disclosed in Japanese Patent Application Publication Laid-Open Hei 10-172464); and (3) a spring-shaped coil may be employed at a part of the electrode (as disclosed in Japanese Patent Application Publication Laid-Open No. 2002-254161).

However, there still remain problems as follows. In the case of (1) where the electrode is divided, the more the number of the electrode increases and the smaller it becomes, the less a high frequency modulated magnetic field is prevented from penetrating. However, as the number of the electrodes increases, the number of components and the time required for assembling the components increase. In the case of (2) where the slit is formed in the electrode, the less an interval between slits is set and the more the number of slits increases, the less the high frequency modulated magnetic field is prevented from penetrating. However, in this case, although difficulty in an assembling process of the electron gun is overcome, it becomes more difficult to accurately form the shape of the electrode with a smaller slit interval and a larger number of slits. In addition, it is also required to have some measure to avoid generation of burr as a measure for avoiding high voltage electric discharge in a portion of the slits. In the case of (3) where the spring-shaped coil is employed at the part of the electrode, the thinner a diameter of the coil wire becomes and the more the number of turns increases, the less the high frequency modulated magnetic field is prevented from penetrating. However, in this case, a strength of the coil for keeping its shape deteriorates, i.e., the coil hangs loosely. In addition, since the spring-shaped coil is formed with the wire by winding, it cannot be employed at a portion where an electron lens is formed, which requires a high circularity and concentricity between electrodes. Furthermore, since the electron gun is operated under a high-voltage condition in a vacuum, a head and an end of the winding portion of the wire should be subjected to some treatment for an anti-electric discharge measure.

Such a situation as described above is not limited to the electromagnetic velocity modulation, and similar problems occur in other electron beam correction by a correction magnetic field when the above-described methods are used for the electrode of the electron gun to which the correction magnetic field is applied.

The present invention provides, in view of the above-described points, an electron gun for a cathode ray tube with an improved high frequency magnetic field transmission characteristic, which can be easily fabricated and assembled, and a display device having the electron gun.

According to an electron gun for a cathode ray tube of the present invention, which applies a correction magnetic field to an electrode of the electron gun to carry out a correction of an electron beam, since at least a part of an electrode in a region which is affected by the correction magnetic field comprises a bellows-like electrode, a high frequency correction magnetic field from outside the cathode ray tube penetrates more into the electrode, a good electron beam correction effect can be obtained without disturbing the magnetic field. When at least a part of at least one electrode of an electrode group constituting a main electron lens of the electron gun comprises a bellows-like electrode, a better magnetic field correction effect can be attained. In a case where a part or an entire of a focus electrode comprises the bellows-like electrode, the magnetic field is received particularly at a portion where the electron beam travels slowly. Accordingly, this case is effective when employed in the magnetic field velocity modulation so that sensitivity of the velocity modulation of the electron beam is improved. According to the present invention, a magnetic field correction, such as a magnetic field modulation, with less magnetic field energy and up to a higher frequency is made possible. Employment of the bellows-like electrode makes it possible to integrally form a support for a bead glass, if necessary, and electrode sag occurring often in the spring-shape coil electrode does not occur and the circularity as an electrode and the concentricity between electrodes can be maintained. In addition, pitch, plate thickness, the number of plates of the bellows can be accurately selected and set so that a desired electron beam correction can be precisely set. Furthermore, when an electrode to which a magnetic field can be penetrate is formed with the bellows-like electrode at a position with a smaller electric field strength, a high processing accuracy is not required so that the electrode can be formed and assembled easierly. Accordingly, an electron gun having an improved sensitivity in magnetic field correction such as the magnetic field modulation can be provided at a lower cost.

According to a display device of the present invention having the above-mentioned electron gun, reliability of the electron gun is improved, the magnetic field correction such as the magnetic field velocity modulation to the electron beam can be carried out appropriately, and a display device with a higher definition quality can be provided.

According to the electron gun for a cathode ray tube of the present invention, since at least a part of the electrode in the region which is affected by the correction magnetic field comprises the bellows-like electrode, a closed circuit of the induced residual eddy current due to the correction magnetic field is shut off and a reverse magnetic field is suppressed to be generated so that the correction magnetic field largely penetrates into the bellows-like electrode and that the magnetic field correction sensitivity to the electron beam is improved. By forming the electrode with the bellows-like electrode, it becomes easier to form and assemble an electrode than the case of improving the magnetic field correction sensitivity with a plurality of separate electrodes as in (1); electrode components can be formed without difficulty as in the case of forming slits in the electrode as described in (2); and a higher accuracy in the electrode shape can be attained than the case of using the spring-shape coil electrode as in the case of (3).

An electron gun for a cathode ray tube according to the present invention comprises a bellows-like electrode at a part of at least one electrode in an electrode group constituting a main electron lens.

Accordingly, the correction magnetic field largely penetrates into the bellows-like electrode and the magnetic field correction sensitivity to the electron beam is improved. The present invention can be applied to any electrode at any position. However, more preferable magnetic field correction becomes possible when applied to a lower voltage electrode portion where the electron beam travels slowly.

The display device according to the present invention comprises the above-described electron gun.

Accordingly, it is possible to obtain a higher magnetic field correction sensitivity to the electron beam, and the magnetic field correction can be appropriately carried out to have a display device with higher definition quality.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a view showing a cathode ray tube according to a first embodiment of the present invention.

FIG. 2 is an enlarged view of a main portion of an electron gun according to the first embodiment of the present invention.

FIG. 3A is a side view of the electron gun according to the first embodiment of the present invention, and FIG. 3B is a cross sectional view of the electron gun according to the first embodiment of the present invention.

FIG. 4A is a view showing an exemplary fabrication process of a bellows-like electrode of the present invention, and FIG. 4B is a final view of the exemplary fabrication process of FIG. 4A.

FIG. 5A is a view showing another exemplary fabrication process of the bellows-like electrode of the present invention, FIG. 5B is a view showing a middle step of the exemplary fabrication process of FIG. 5B, and FIG. 5C is a final view of the exemplary fabrication process of FIG. 5A.

FIG. 6 is an exploded view of another bellows-like electrode of the present invention.

FIG. 7 is a graph showing relationship between a frequency of a modulation magnetic field and a modulation degree for explaining the present invention.

### DESCRIPTION OF THE PREFERRED EMBODIMENTS

An electron gun for a cathode ray tube according to the present invention comprises a plurality of electrodes, and at least a part of an electrode in a region which is affected by the correction magnetic field comprises a bellows-like electrode. Another electron gun for a cathode ray tube according to the present invention comprises a plurality of electrodes, and a part or an entire of at least one electrode of an electrode group constituting a main electron lens comprises a bellows-like electrode. A correction magnetic field applied to the electron beam may include: a magnetic field for velocity modulation for modulating a scanning velocity of the electron beam in order to emphasize an outline of an image; a quadruple magnetic field for correcting a beam spot distortion at a peripheral part of the image; a magnetic field for keystone correction for correcting a distortion (usually a wide-top narrow-bottom effect) of the image; a magnetic field for keystone distortion used for a projector having three monochromatic cathode ray tubes to make two screens projected by two cathode ray tubes disposed on both sides distorted in advance, or other correction magnetic fields. At least a part or an entire of a focus electrode in an electrode group constituting a main electron lens can be formed with the bellows-like electrode.

A display device according to the present invention comprises a cathode ray tube having any one of the above-described electron guns.

Now, with reference to the attached drawings, embodiments of the present invention will be described.

FIG. 1 shows an embodiment of a cathode ray tube according to the present invention. The present embodiment is a case where the present invention is applied to a monochrome cathode ray tube which may be employed in a projector or the like. A cathode ray tube 1 of the present embodiment has a monochrome fluorescence screen 3 formed on an inner plane of a panel 2P of a tube (glass tube) 2 and an electron gun 4 according to the present invention disposed in a neck portion 2N. There is disposed a deflection yoke 5 outside the tube, for deflecting an electron beam B from the electron gun 4 in horizontal and vertical directions. Outside the neck portion 2N, magnetic field generation means for generating a correction magnetic field for electromagnetic velocity modulation. In this case, a bipolar electromagnetic coil 6 being an electromagnetic velocity modulation coil is disposed there. The bipolar electromagnetic coil 6 is disposed at a position corresponding to a necessary electrode described below. Depicted with a reference numeral 7 is a 4-pole or 6-pole correction coil for positively causing keystone distortion on cathode ray tubes on both sides, for example, a red one and a blue one, while a reference numeral 8 depicts an anode button for supplying an anode voltage. In the cathode ray tube 1, the electron beam B emitted from a cathode of the electron gun 4 is converged with a main electron lens constituted with a plurality of electrodes and is focused on the fluorescence screen 3. This electron beam B is deflected in the horizontal and vertical directions by the deflection yoke 5 so that a desired image is displayed. The electron beam passing through the electron gun 4 is subjected to the velocity modulation by a high frequency modulation magnetic field caused by the bipolar electromagnetic coil 6, and the image is displayed with an emphasized outline. In the projector, three cathode ray tubes 1 (1R, 1G, 1B) corresponding to red, green and blue are disposed. Images in each of these three colors emitted from respective cathode ray tubes 1R, 1G, 1B are projected through respective lens on the screen to display a desired color image.

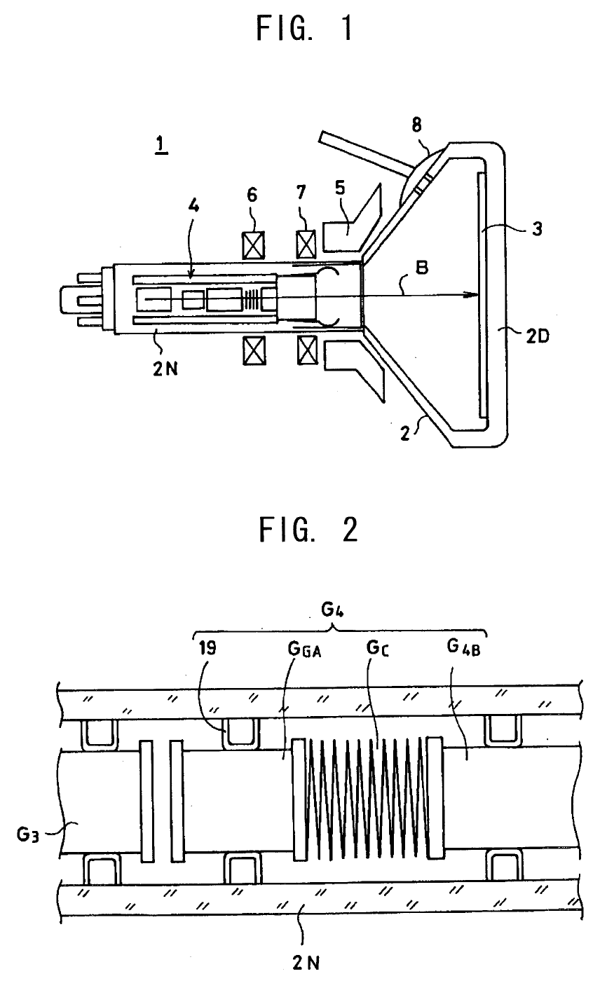

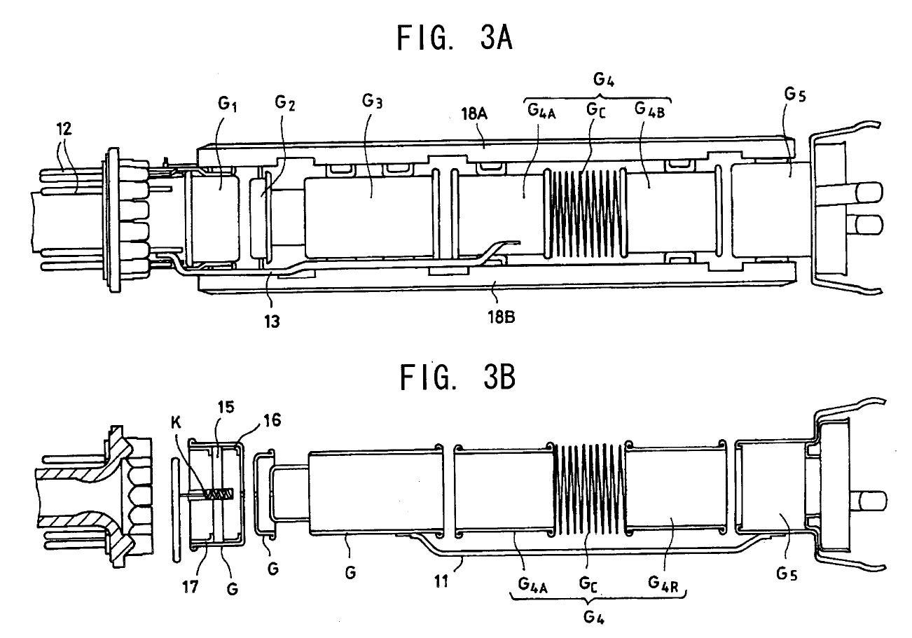

FIGS. 3A and 3B show an embodiment of the electron gun 4 in the cathode ray tube 1. FIG. 2 is an enlarged view of a main portion of the electron gun 4. The electron gun 4 of the present embodiment comprises a cathode K, a first electrode G1, a second electrode G2, a third electrode G3, a fourth electrode G4 and a fifth electrode G5 disposed on a same axis. The fifth electrode G5 and the third electrode G3 are connected to each other with a connection line 11, and the anode voltage is applied to them from the anode button 8. A focus voltage is applied to the fourth electrode G4 through a stem pin 12 and a connection line 13. The third electrode G3, the fourth electrode G4 and the fifth electrode G5 constitute a uni-potential type main electron lens. To the first electrode G1 and the second electrode G2, a required low voltage is applied from the stem pin 12. The cathode K is supported by an insulation board 15 in a manner that it penetrates the board 15, is inserted into the first electrode G1 via a spacer 16, and is fixed in the first electrode G1 through a retainer 17 by welding or the like. The first electrode G1 to the fifth electrode G5 are arranged to have a predetermined interval therebetween and they are supported by a pair of bead glasses via a metal support 19 fixed to these electrodes by welding.

In the present embodiment, a bellows-like electrode GC formed with a plurality of continuous ring-like thin plates having conductivity by alternately folding to have an accordion-like shape is positioned at a center portion of the fourth electrode at which the electron beam travels slowly to have a focus electrode G4 having the bellows-like electrode GC sandwiched therein. The bellows-like electrode GC, in the figures, is positioned between cylindrical focus electrode units G4A and G4B and fixedly adhered thereto by welding or the like. Therefore, the focus electrode G4 comprises the electrode units G4A, G4B and the bellows-like electrode GC sandwiched therebetween. The bipolar electromagnetic coil 6 is disposed at a position corresponding to the bellows-like electrode GC of the focus electrode G4.

In this case, a lens effect of the main electron lens is produced at a gap portion between the focus electrode G4 with a low voltage and the third electrode G3 and the fifth electrode G5 with a high voltage opposed thereto. The bellows-like electrode GC is arranged at a position where such a lens effect does not occur. According to this arrangement, even in a case where the bellows-like electrode GC is formed roughly, an assembling accuracy of the electron lens is not affected.

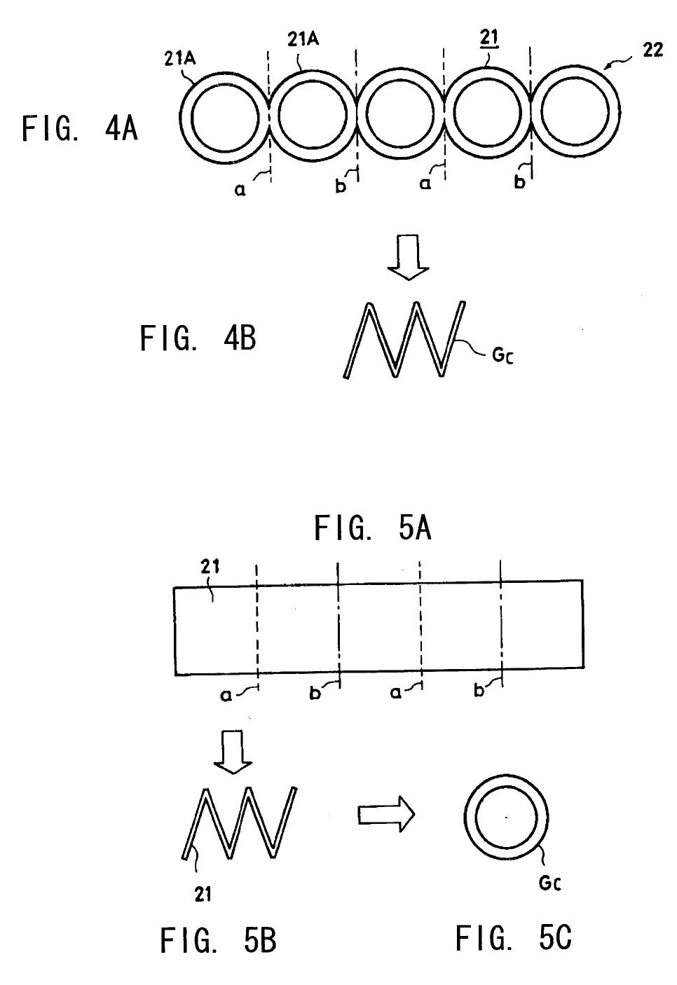

Next, the method of fabricating the bellows-like electrode GC will be explained. FIG. 4 illustrates an example of a fabrication process of the bellows-like electrode GC. According to the method, a metal plate 21 is previously cut and a hole is made thereon by pressing work so as to have a strip-like member 22 comprising a plurality of continuous ring members, in this case, a plurality of ring members 21A continuous at a part thereof (see FIG. 4A). Thereafter, junctions “a” of each of the ring members 21A appearing alternately are mountain-folded and the other junctions “b” are valley-folded to have the bellows-like electrode GC (see FIG. 4B). FIG. 5 shows another example of the fabrication process of the bellows-like electrode GC. In the method, converse to the above case, the strip-like metal plate 21 is prepared (FIG. 5A), provided with a plurality of equally spaced fold lines. The fold lines correspond to the junctions in the case of FIGS. 4A and 4B. Fold lines “a” appearing alternately are mountain-folded and the other fold lines “b” are valley-folded to be accordion folded (FIG. 5B). Thereafter, the folded metal plate 21 is press worked to cut and have a hole to have the bellows-like electrode GC (FIG. 5C).

In the figures, the number of bellows in the bellows-like electrode GC is five, that is, the bellows-like electrode GC is four times folded. However, any number of bellows is allowable. Details of the bellows-like electrode GC, such as an outer diameter, an inner diameter, a thickness and the number of bellow plates, and a length of the bellows-like electrode GC, are set in accordance with a size of the cathode ray tube and a neck diameter of the tube thereof. For example, a preferable specific example in a case of applying the present invention to a monochrome cathode ray tube or a projector having a fluorescence screen of 16 cm (7 inches) and a neck diameter of 29.1 mm is as follows:

| | | |
|---|---|---|
| outer diameter of bellow plate: | 12.0 | mm f |
| inner diameter of bellow plate: | 8.0 | mm f |
| thickness of bellow plate: | 0.2 | mm |
| number of bellow plates: | 17 | |
| length of bellows: | 10.0 | mm |

Intervals between the bellows depend on a radial direction electrode width of the accordion electrode (half of a difference in inside radius) and a distance between an outer diameter of the accordion electrode and an inside diameter of the CRT neck. However, it is preferable to be about the radial direction electrode width or less (in the above case, up to 2.0 mm). If it is larger, the electrode is easily influenced by the external electric field.

FIG. 7 is a graph which shows an effect of the cathode ray tube 1 according to the present embodiment. This graph shows relationship between a frequency of a modulation magnetic field (a horizontal axis) and a magnetic field modulation degree, a so-called modulation sensitivity (a vertical axis). Here, the modulation degree is an amplitude of an electron beam brightness point on the fluorescence screen 3 when a frequency of constant energy is applied to the bipolar electromagnetic coil 6, that is, it shows amplitude widths w1 and w2 between centers of the electron beam in FIG. 7. The larger the value becomes, the larger the effect of the magnetic field modulation is. In FIG. 7, a curve “X” shows a case of the cathode ray tube of the present embodiment having the bellows-like electrode GC, a curve “Y” shows a case of a cathode ray tube for reference without the bellows-like electrode GC. In the case of the cathode ray tube of the present embodiment, the amplitude width w1 of the electron beam is large, the correction sensitivity of the velocity modulation correction by the magnetic field is high. In the case of the reference cathode ray tube, the amplitude width w2 of the electron beam is small, and the correction sensitivity of the velocity modulation correction is low.

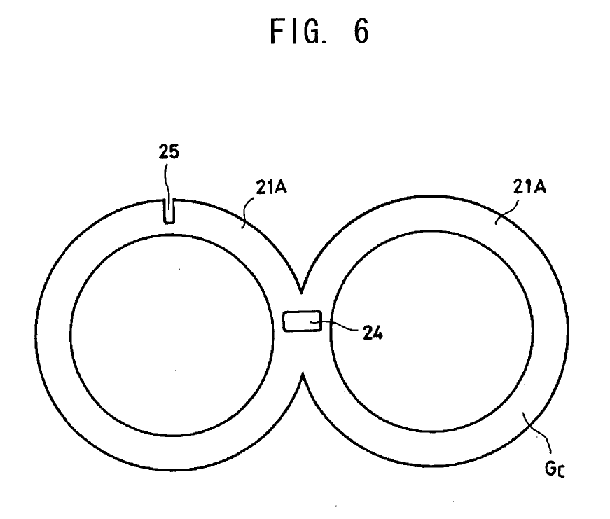

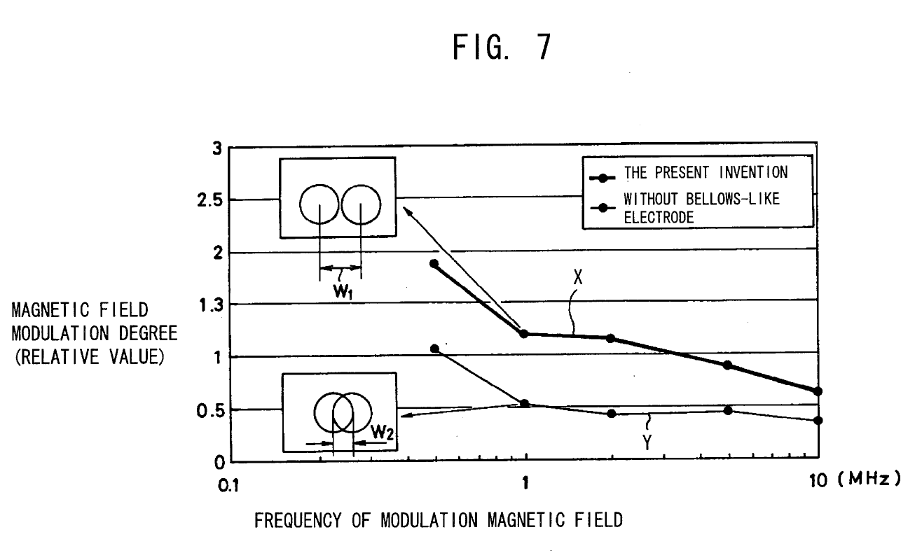

In addition, in the electron gun 4 having the bellows-like electrode GC, in a case where a further higher frequency magnetic field that may introduce a problem due to a magnetic field induced residual eddy current within a plate thickness of the electrode, a method to reduce influence of the magnetic field induced residual eddy current effect may be employed. According to the method, a slit 24 may be provided at a junction of the bellow plate, that is, the ring member 21A, or a notch 25 may be provided at a part of the ring member 21A, as shown in FIG. 6.

In the above-described embodiment, the bellows-like electrode GC is provided at a portion having a low electric field strength at the center of the long focus electrode G4. According to the arrangement, the following effect may be attained:

1) Since the electric field strength is low at the position of the bellows-like electrode GC, the shape accuracy of the electrode including the circularity and the concentricity between electrodes does not affect on distortion of the electron lens. Accordingly, in this case, high processing precision is not required for fabricating the bellows-like electrode GC so that the electrode can be easily formed and assembled.

2) Since the electric potential of the bellows-like electrode GC is low and the electron beam travels slower, the magnetic field may easily and accurately change a direction of the electron beam so that the sensitivity of the velocity modulation of the electron beam by the magnetic field can be improved.

In addition, the present invention may be applied to a case of magnetic field modulation at a portion having a high electric field strength of the electron gun. In this case, contrary to the above-described case, the shape of the bellows-like electrode, including the circularity and the concentricity between the electrodes, is not accurately formed, the electron beam is distorted and a resolution of the CRT is deteriorated. However, in the case of the bellows-like electrode, its outer shape and inner hole can be formed easily by pressing work and the shape accuracy can be ensured. In addition, when folding the electrode, since the bellow-like electrode GC may have the support to the bead glass 18A and 18B integrally formed at a part thereof, the shape of the electrode can be maintained without sagging so that the circularity and the concentricity between electrodes of the passing hole of the electron beam can be highly accurately maintained. On the other hand, it is difficult to employ the spring-shaped coil electrode, which also improves sensitivity of the magnetic field modulation correction as the bellows-like electrode, since it has problems in bending accuracy of the wire and possibility of sagging.

In the above embodiment, the present invention is applied to the monochrome cathode ray tube used for a projector. However, the present invention is not limited to the case and it can also be applied to a color cathode ray tube and the like. If a shape of an electrode is oval, the ring member of the bellows-like electrode GC may have an inside diameter in the oval shape. The present invention can also be applied to a so-called single electron gun with multi-beam as the color cathode ray tube. In the single electron gun with multi-beam, three electron beams may cross at the center of a main electron lens and may be converged on the fluorescence screen through an electrostatic convergence means. The present invention may also be applied to an electron gun for color cathode ray tubes having three guns. The present invention may also be applied to a bi-potential type electron gun.

Since the velocity modulation correction sensitivity by the magnetic field can be obtained higher when the electron beam travels slower, the bellows-like electrode GC is preferably to be disposed on a side of the electrode with a lower electric potential. Therefore, the bellows-like electrode GC may be provided at the electrode where the electron beam travels slowly, other than the focus electrode. Depending on a design, the bellows-like electrode GC may be provided at the electrode with a higher voltage.

In the above-described embodiment, the bellows-like electrode GC is provided at a part of the focus electrode. However, all of the focus electrode may comprise the bellows-like electrode GC. At least a part of at least one electrode of an electrode group constituting the main electron lens may comprise the bellows-like electrode GC. In a case of providing the bellows-like electrode GC to the other electrode as well as the focus electrode, a part or an entire electrode may comprise the bellows-like electrode GC.

As described above, various kinds of correction magnetic fields are applied to the electron beam of the electron gun from outside in accordance with an object. Therefore, in the present invention, in order to make the correction magnetic field penetrate into the electrode more to improve the correction sensitivity, the bellows-like electrode GC may be used in the electrode in a region affected by the correction magnetic field, including a quadruple magnetic field, a magnetic field for keystone distortion, a magnetic field for keystone correction as well as the magnetic field for velocity modulation. For example, in FIG. 1, the correction coil 7 is disposed at a position corresponding to the fifth electrode G5. In this case, if a part or an entire fifth electrode G5 is composed of the bellows-like electrode GC, power consumption of the correction coil can be reduced.

According to the present invention, a cathode ray tube having any electron guns of the above-described embodiments, for example, a plurality of monochrome cathode ray tubes 1 having a monochrome electron gun 4 as shown in FIG. 3 may be employed in a projector or a color cathode ray tube having an electron gun of the multiple electron beam type may be employed in a display device including a television set, a monitor, a display or the like. According to the display device, a beam correction effect, in particular, an electron beam modulation effect against a high frequency correction magnetic field (a velocity modulation magnetic field, a quadruple magnetic field, a magnetic field for keystone correction or a magnetic field for keystone distortion) from outside the cathode ray tube, in particular, against a high frequency modulation magnetic field, can be obtained so that a high definition display device can be provided.

Although the invention has been described in its preferred form with a certain degree of particularity, obviously many changes and variations are possible therein. It is therefore to be understood that the present invention may be practiced otherwise than as specifically described herein without departing from the scope and the sprit thereof.

What is claimed is:

1. An electron gun for a cathode ray tube, which applies a correction magnetic field to an electrode of the electron gun to carry out a correction of an electron beam, wherein at least a part of an electrode in a region which is affected by said correction magnetic field comprises a bellows-like electrode.

2. An electron gun for a cathode ray tube having an electrode group constituting a main electron lens, wherein at least a part of at least one electrode of said electrode group constituting the main electron lens comprises a bellows-like electrode.

3. The electron gun for a cathode ray tube according to claim 2, wherein at least a part of a focus electrode in said electrode group constituting the main electron lens comprises a bellows-like electrode.

4. The electron gun for a cathode ray tube according to claim 2, wherein an entire of said focus electrode comprises a bellows-like electrode.

5. The electron gun for a cathode ray tube according to claim 1, wherein said correction magnetic field is any one of a velocity modulation magnetic field, a quadruple magnetic field, a magnetic field for keystone distortion correction and a magnetic field for keystone distortion.

6. A display device comprising an electron gun that at least a part of an electrode in a region which is affected by a correction magnetic field comprises a bellows-like electrode.

7. A display device comprising an electron gun that at least a part of at least one electrode of an electrode group constituting a main electron lens comprises a bellows-like electrode.

8. A display device according to claim 7, wherein at least a part of a focus electrode in said electron gun comprises a bellows-like electrode.

9. A display device according to claim 7, wherein an entire of a focus electrode in said electron gun comprises a bellows-like electrode.

10. The display device according to claim 6, wherein said correction magnetic field is any one of a velocity modulation magnetic field, a quadruple magnetic field, a magnetic field for keystone distortion correction and a magnetic field for keystone distortion.
